(19) United States
(12) Patent Application Publication
(10) Pub. No.: US 2010/0104700 A1
(43) Pub. Date: Apr. 29, 2010

(54) CONFECTIONERY PRODUCT

(75) Inventors: Thomas Kmietsch, Marysville, OH (US); Adrienno Holmes, Poppy Lane, OH (US)

Correspondence Address: K&L Gates LLP, P.O. Box 1135, CHICAGO, IL, 60690, US

(73) Assignee: NESTEC S.A., Vevey (CH)

(21) Appl. No.: 12/259,019

(22) Filed: Oct. 27, 2008

(51) Int. Cl. A23G 3/54; A23G 3/36; A23P 1/16; A23G 3/52

(52) U.S. Cl. 426/103; 426/516

(57) ABSTRACT

A sugar confectionery mass having a light texture comprising a chemically aerated high-boil sugar material interspersed with layers of a fat-based material and method for making the same.

### FIELD OF THE INVENTION

The present invention relates to a sugar confectionery mass having a light texture comprising a chemically aerated high-boil sugar material interspersed with layers of a fat-based material.

### BACKGROUND

Confectionery products comprising high-boil sugar masses are well known. For example Nestle's Violet Crumble and Cadbury's Crunchie products both comprise high-boil honeycomb centres enrobed with chocolate. Such high boil sugar masses may be made by metering sodium bicarbonate into a high-boil sugar solution as described in Chocolate, Cocoa, and Confectionery: Science and Technology Third Edition, Bernard W. Minifie, Avi Book, New York, pg. 561-564. These products have a typical density of approximately 0.6 g/ml and appeal to consumers because of their light crunchy texture although some consumers may consider the product to be unexciting because it is a single mass product.

Layered confectionery products are also well known. Nestle's Butterfinger comprises multiple and very thin layers of a non-aerated high-boil mass with interspersed multiple layers of peanut butter. The Butterfinger product has a typical density of approximately 1.2 g/ml and a light crunchy texture due to the thin-layered high boil mass but some consumers describe a negative toothpacking effect, as well as inconsistent, hard sugar pockets within the final product.

U.S. Pat. No. 6,183,799 describes a process for producing such a laminated edible product by extruding from the exit port of a coaxial die a thin strip of a lipid-based fluid material encased in a layer of a high-boil sugar mass, depositing the thin strip on a support, and superimposing an additional thin strip on top of the first thin strip. This patent describes the method in relation to aerated sugar masses made by the incorporation of air but does not describe the method in relation to low density chemically aerated sugar masses. It is not apparent that the method will work successfully with such low density chemically aerated materials and various problems are expected. These include inconsistent, uneven material flows, and inconsistent deposit and/or extrusion of an aerated high-boil material, as well as loss of aeration and/or non-uniform aeration in the final product. Additionally, the stability of the aerated structure after deposit/extrusion is unknown, especially as it is possible that the layers need to be tempered gradually to prevent collapse of the internal structure.

There is a need for further confectionery products which overcome the disadvantages discussed above.

### SUMMARY

Accordingly, in a first aspect the present invention provides a confectionery mass comprising a high-boil sugar material interspersed with layers of a fat-based material wherein the high-boil sugar material is chemically aerated. The chemical aeration of the high-boil sugar material has a significant impact on the overall density of the laminated confectionery mass and results in a light-textured, crispy confectionery. Thus, by combining chemical aeration and lamination the invention provides a product which has a desirable and exciting eating texture which could range from crispy and creamy to crunchy and light, depending on the level of aeration and the components making up the layered mass. The invention also provides a sugar-based confectionery mass having the indulgence associated with a fat-based material. Advantageously, there is a reduction in the negative toothpacking effect which is normally associated with high-boil sugar masses. The confectionery mass also has an improved flavour and novel visual appearance.

The fat-based material may optionally be aerated, either chemically (e.g., using sodium bicarbonate), or mechanically (e.g., using air or other gas). Thus, products have lighter densities and different textures may be achieved.

In a second aspect the invention provides a method of making a confectionery mass comprising a high boil sugar material interspersed with layers of a fat-based material comprising:

chemically aerating a high-boil sugar material and optionally aerating a fat-based material;

extruding a stream of the fat-based material and the high-boil sugar material onto a support, wherein the fat-based material and the high-boil sugar material are not miscible;

extruding subsequent material stream upon earlier-extruded material stream on the support to create a laminated confectionery mass.

The method successfully incorporates the use of a chemically aerated high boil sugar material into the layering technology discussed above without significant loss of aeration in the final product.

Additional features and advantages are described herein, and will be apparent from the following Detailed Description and the figures.

### BRIEF DESCRIPTION OF THE FIGURES

FIG. 1 shows an illustration of a randomly-uniform laminated structure comprising thin layers of a high-boil sugar material (unshaded) interspersed with, or scattered among or between, thin layers of a fat-based material (shaded).

FIG. 2 shows a die head suitable for extruding a high-boil sugar material through an outer (or encapsulating) slot (1) and a fat-based material through an inner (or centre) slot (2).

### DETAILED DESCRIPTION

As used herein a high-boil sugar material or mass is any hard sugar product produced by methods known to those of ordinary skill in the art. Accordingly, a sugar syrup is usually precooked and then boiled to produce a boiled sugar mass. The sugar syrup may include, for example, corn syrup, granulated sugar, reducing sugars, and water, a gelling agent such as hydrated gelatine, and, optionally, flavours and/or colours. Suitable flavours include, but are not limited to, molasses, salt and vanilla flavours. Colourings may be, for example, molasses and/or FD&C food colours. The sugar mass may also be combined with rework from previous manufacturing processes. The moisture content of the unboiled sugar syrup may be approximately 20 to 30 percent by weight. The boiled sugar mass may be preheated with a controlled moisture “flash-off” under atmospheric or pressurized conditions, followed by a cook stage and moisture “flash-off” under controlled conditions (atmospheric or vacuum). The final cooked sugar solution may have a total moisture content of between 2 and 5% by weight.

As used herein a fat-based material is a material having fat as the continuous phase such that the matrix of the material is fat based. The material may be solid or liquid at room temperature. Examples of fat-based fluid materials include peanut butter, praline, such as almond praline, nut paste, such as hazelnut paste, chocolate, including white, milk or dark chocolate and chocolate substitutes. Optionally, the fat-based fluid material may be aerated, either by mechanical or chemical means.

According to the invention the high-boil sugar material is chemically aerated. Chemical aeration may be achieved by the use of sodium bicarbonate. Sodium bicarbonate reacts under specific conditions to release CO₂ gas which is responsible for the “aeration” of the material. A gelling agent (e.g. Gelatin) creates a matrix within the sugar high-boil which will prevent the gas from dissipating and maintain the aerated structure. Sodium bicarbonate may be added in any suitable form, for example dry powder or liquid slurry. Dry powder can be purchased in various grades, from ultra-fine (20 microns) to coarse (in excess of 100 microns). The use of an ultra-fine powder has significant benefits, in that the reaction time is quicker (the smaller particles present a greater surface area available for reaction), a more uniform level of aeration is achieved throughout the mass, and the reactive process is complete in a short period of time, such that the product does not continue to “grow” as gas continues to be released. A sodium bicarbonate slurry may also be used and in this case the liquid phase (e.g. invert sugar, corn syrup, water) should be selected so as to ensure that excess moisture is not added back into the cooked sugar high-boil. The amount of sodium bicarbonate may be selected based on the desired level of aeration and the form in which it is to be added to the sugar high-boil. Preferred concentrations range from 0.5 to 1.5%. Reaction times are dependant on the particle size of the powder used and on the mixing process for blending of the powder into the sugar high-boil. This time can vary from a matter of seconds (<10 seconds) to a matter of minutes (>2 minutes).

The fat-based material may additionally be aerated and this may be achieved by mechanical or chemical means. Chemical aeration may be achieved as discussed above. Mechanical aeration may be achieved using air and other gases such as carbon dioxide or nitrogen. Such gases are commonly used for aerating confectionary masses.

The advantage of chemical aeration over aeration by mechanical or other means is that chemical aeration is simple, effective and easy-to-use, requiring none of the complex procedures associated with the handling of pressurized gas containers and the subsequent heating and mixing processes required to ensure a homogenous mix of the high-boil sugar and gas. This is particularly true when the chemical aeration is achieved using sodium bicarbonate.

Preferably, the high-boil sugar material is chemically aerated and has a density of from 0.3 g/ml to 0.8 g/ml. Additionally, the fat-based material may be aerated and may have a density of from 0.3 g/ml to 0.8 g/ml. In order for the fat-based material to remain aerated after co-extrusion, it may be necessary to ensure that the fat-based material is not be heated past its melting point during the co-extrusion process as this could allow the air previously incorporated into the material to dissipate due to the reduced viscosity of the fat-based material.

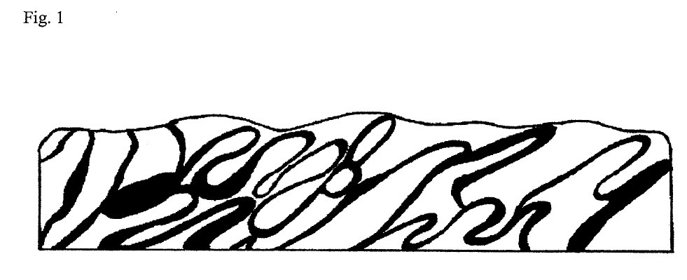

The confectionery mass of the invention comprises a high-boil sugar material interspersed with layers of a fat-based material wherein the high-boil sugar material is chemically aerated and the fat-based material is optionally aerated. Thus, the confectionery mass has a laminated structure comprising thin layers of the high-boil sugar material interspersed with, or scattered among or between, thin layers of the fat-based material. The laminated structure is randomly uniform, with the thickness of the layers defined by the design of the die-head, and product flow and distribution rates as discussed below. Accordingly, as used herein the term ‘layers’ may include small patches or pockets. FIG. 1 illustrates such a randomly-uniform laminated structure. It can be seen that the structure comprises thin layers of the high-boil sugar material (unshaded) interspersed with, or scattered among or between, thin layers of the fat-based material (shaded).

Preferably, the layers of aerated high-boil sugar material have an average thickness of from 0.5 to 50 mm, more preferably from 3 to 30 mm, and most preferably from 5 to 10 mm. Preferably, the layers of aerated high-boil sugar material are thick enough that the consumer can detect the aeration upon consumption. Preferably, the layers of fat-based material have an average thickness of from 0.25 to 30 mm, more preferably from 0.5 to 10 mm, and most preferably from 1 to 5 mm. Of course, when an aerated fat-based material is used, the layers may have a greater average thickness than when a non-aerated fat-based material is used. For example, when the fat-based material is aerated, the layers may preferably have an average thickness of from 10 to 20 mm and when the fat-based material is not aerated, the layers may preferably have an average thickness of from 1 to 5 mm.

Preferably, the confectionery mass has a density of from 0.4 g/ml to 1.2 g/ml and most preferably from 0.6 g/ml to 1.0 g/ml. The chemical aeration of the high-boil sugar material has a significant impact on the overall density of the laminated confectionery mass.

Any convenient ratio of aerated high-boil sugar material to fat-based material may be used in the confectionery mass according to the invention, for example from 10%:90% to 90%:10%. However, it may be preferred to use a ratio of aerated high-boil sugar material to fat-based material of from 40%:60% to 60%:40% based on the weight of the materials. The preferred ratio of aerated high-boil sugar material to fat-based material is 50:50, by weight.

The invention also provides a method of making a confectionery mass comprising a high-boil sugar material interspersed with layers or pockets of a fat-based material comprising:

chemically aerating a high-boil sugar material and optionally aerating a fat-based material;

extruding a stream of the fat-based material and the high-boil sugar material onto a support, wherein the fat-based material and the high-boil sugar material are not miscible;

extruding subsequent material stream upon earlier-extruded material stream on the support to create a laminated confectionery mass.

In preferred embodiments the method may comprise one or more of the following steps:

chemically aerating a high-boil sugar material using sodium bicarbonate and optionally aerating a fat-based material;

transferring the fat-based material and the aerated high-boil sugar material to a die-head. The die head may be designed to keep the two materials separate and immiscible as they discharge from the die-head in a single material stream.

extruding the material stream discharged from the die-head to a support (such as a conveyor belt);

continuously extruding subsequent material stream upon earlier-extruded material stream on the support to create a randomly-uniform laminated confectionery mass;

continuously transferring the extruded confectionery mass on the support away from the extrusion zone to provide space for the material stream being continually discharged.

This method is explained in more detail below. The chemical aeration is described in relation to the high-boil sugar material, although the fat-based material could also be aerated using chemical or mechanical means.

A high-boil sugar material is prepared by any known method. For example, sugar, glucose syrup and water may be blended and pre-heated to 110° C. A hydrated Gelatin is added to the pre-cooked syrup, and the batch is cooked to approx. 150° C., targeting a final moisture content of 1 to 2%. It is preferred to use a continuous process for cooking, as this is quicker and does not damage, burn or deactivate individual components. As a comparison, a 70 kg batch can take up to 2 hours to bring to temperature, whereas the same batch cooked continuously can be brought to temperature within 2 to 5 minutes. The big advantage of the reduced cook time is that the sucrose is not exposed to extreme temperatures for extended periods, with the result that the formation of reducing sugars (caused by the breakdown of sucrose) is limited (an increase in reducing sugars increases the stickiness and toothpacking effect in the final product). Irrespective of the cook process, the final cooked sugar solution is maintained at a temperature of 140° to 145° C. In a batch operation, this would be in the cook vessel, or in an intermediate holding vessel, while in the continuous process the cooked mass is pumped directly from the cooker through heated piping (150° C.) to a single or twin-screw extruder. The sodium bicarbonate is metered into the syrup stream or into the extruder itself and the extruder has the function of properly mixing the sugar solution and sodium bicarbonate. The equipment used for this operation can be any unit which guarantees efficient mixing and distribution of the sodium bicarbonate within the sugar solution and does not necessarily need to be an extruder.

Aeration of the sugar solution may be achieved by the addition of sodium bicarbonate. Approximately from 0.5 to 1.5% by weight sodium bicarbonate may be used, depending on the particle size of the sodium bicarbonate. The defined quantity of sodium bicarbonate is metered into the mixing vessel using a screw-feeder (single or twin-screw). It is important that the same amount of sodium bicarbonate is delivered throughout the metering process, so some sifting of the powder may be advantageous prior to start-up to ensure that the powder is fluffy and free of lumps. The level of aeration can be controlled in a number of ways:

Selection of powder grade—average particle size is preferably from 10 to 120 μm, most preferably from 20 to 30 μm—ultra-fine may be more beneficial than coarse grade powders, as the reaction is immediate and uniform due to the increased surface area exposed to react.

Level of mixing—Over-mixing (i.e., in excess of 30 seconds at a mixer speed of >50 rpm) may have the effect of collapsing the aerated structure. As aeration tends to lighten the colour of a material, over-mixing may also have the effect of discolouring the structure. On the other hand, under-mixing (i.e., for less than 10 seconds at a mixer speed of <50 rpm) may not be sufficient to distribute the sodium bicarbonate evenly in the high-boil sugar mass.

Dwell time of the sugar solution and the sodium bicarbonate in the mixer.

The syrup temperature prior to the addition of the sodium bicarbonate is preferably from 130° to 160° C., most preferably from 140° to 150° C.—the higher the temperature, the easier it is to mix the powder into the sugar. Lower syrup temperatures decrease the syrup viscosity, make it thicker, and more difficult to handle and mix.

The aerated sugar material may be discharged from the mixing vessel (twin-screw extruder or other mixer) into an intermediate, heated (approximately 150° C.) holding vessel. The aim is to maintain a minimum level of product in this vessel and to use it purely to provide sufficient product “head” to supply a continuous flow of product to a pump located directly below the holding vessel. The pump transfers the aerated sugar high-boil through heated pipes (approximately 150° C.) to the co-extrusion die-head mounted to the laminator. The laminator may be a coaxial unit which can be moved across the width or length (or both) of the target extrusion area, typically a conveyor belt made of heat-resistant plastic or silicone-type materials. Alternatively, the laminator can be kept stationary during extrusion. This would depend on the dimensions of the die-head and the dimensions of the product sheet one is aiming for. A pump is selected which will maintain levels of aeration and prevent excessive shearing which would damage the aerated structure. The most important point is that the pump is heated (approximately 150° C.) to prevent crystallization of the aerated sugar solution upon impact with a cold surface. Pump design and operation are also important, with many positive displacement pumps, such as gear, piston, rotary lobe/vane, diaphragm and peristaltic pumps, all finding potential application for this process.

The rate of product discharge is determined by the quantity of product discharged from the cook process—all subsequent operations are scaled to the flow of product coming from the cooker. This flow is rate-checked prior to transfer to the extruder, and needs to be maintained to ensure uniform, even flow through the die-head.

A fat-based material is prepared by any known method. For example, an almond praline may be prepared by mixing sugar with roasted almonds, adding cocoa butter or a cocoa butter equivalent to achieve a moist, wet mass (forms a lump when pressed together in your hands), and refining to a particle size of 30 μm. The refined flake is added to a mixer/conche, where additional cocoa butter or an equivalent is added, and the mixture is mixed/conched for 2 to 3 hours. The material may be held in a holding vessel for tempering purposes prior to transfer to the coaxial die. Depending on the nature of the fat-based material, this may be achieved by circulating the material through a pump and back into the kettle until the target temperature has been reached. This process has the advantage of keeping the discharge line clear, and helps to prevent line blockages when the flow is diverted to the die-head. Target temperatures are typically between 32° and 45° C., depending on the material.

One or more fat-based materials may be extruded from the coaxial die to form a multi-layered fat-based material encased in the aerated sugar material. In addition, more than one fat-based material may be extruded from the coaxial die to form a single layer of fat-based material encased in the aerated sugar material as and wherein the fat-based materials are adjacent to each other. One of ordinary skill in the art would readily know how to re-design the die-head so as to produce such products.

Suitable coaxial dies are described in U.S. Pat. No. 6,183,799.

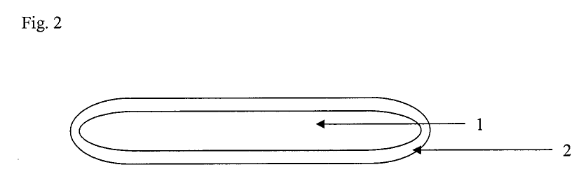

The coaxial die has a die head which extrudes the high-boil sugar material through an outer (or encapsulating) slot and the fat-based material through an inner (or centre) slot. As shown in FIG. 2, the outer slot (1) encapsulates the inner slot (2). The die-head will keep the two materials discrete and separate until the point of discharge from the die-head. The die head may be designed to keep the two materials separate and immiscible as they discharge from the die-head in a single material stream. The fat-based material is preferably encapsulated by the aerated high-boil sugar material at the point of discharge, wherein the fat-based material and the high-boil sugar material are not miscible (which may be defined by similar product densities).

Typical dimensions of the slots are as follows:

Centre Slot: Length of slot=6-7 cm
Width of slot=0.2-0.3 cm
Available surface area=1-2 cm²

Encapsulating Slot: Length of slot=7-8 cm (×2)
Width of slot=0.1-0.2 cm (×2)
Approximate available surface area=2-3 cm²

However, other dimensions may be selected by the skilled person based on the materials being run through the system, the visual and textural impact one is trying to achieve, and on the ratios of the individual materials to one another. For example, if one is looking at layering two materials of similar density (e.g., both materials aerated), the ratio of the two materials could be anywhere from 10 to 90% of the one material versus the second material, or vice versa. For the aerated version with the reduced-density encapsulating material, this ratio is likely to be between 20 and 50% high-boil versus fat-based material. The size (length and width) of the slots themselves depends on the throughput being targeted—too large would result in an incomplete material stream, whereas too small would not give the targeted throughputs.

A stream of fat-based material and high-boil sugar material exits from the coaxial die head. Preferably the fat-based material is encased in a layer of aerated high-boil sugar material. Preferred rates of discharge from the coaxial die may be a volume of 300 kg per hour finished product, of which the aerated sugar high-boil is between 105 and 210 kg of this total (35 to 70% of the total).

The material stream is extruded onto a support, such as a conveyor belt, which may be responsible for transferring the extrudate into a cooling/tempering zone. The material stream continuously extrudes upon itself on the support to create a randomly-uniform laminated confectionery mass. The extruded confectionery mass on the support may be continuously transferred away from the extrusion zone to provide space for the material stream being continually discharged.

The speed of the belt, the design of the die-head, and/or the movement of the die-head across the surface of the belt, may be responsible for allowing the extruded material stream to festoon (fall upon itself), in the process creating multiple alternating layers of aerated high-boil sugar and fat-based material.

The material stream can be layered on top of itself (festooned) by collecting the material stream on a belt which oscillates back and forth under the exit port of the die-head. In another embodiment of the invention, the material stream may be layered on top of itself by slinging the material stream. The slinging can be achieved by oscillating the die-head back and forth using both axes. Thus, the material stream is layered on top of itself by oscillating the die assembly over a support, such as a slow moving conveyor belt. In this embodiment, the twin screw extruder may be attached to the coaxial die with a flexible hose to permit the die to oscillate. Alternatively, both the die and the belt may be oscillated. The die is oscillated in one direction, for example the X direction, and the belt is oscillated in a direction perpendicular to the direction of oscillation of the coaxial die, i.e., the Y direction. This allows the material stream to be layered over the entire width of the belt. The rate of oscillation of the die head or conveyor may be altered to adjust the thickness of the layers. The resulting stack can then be further processed. For example, the stack can be folded on top of itself or thinned down by rolling to form thicker or thinner product sheets, which are then formed into the desired format.

A number of factors influence the extrusion process, and help to define the layers which are ultimately formed:

Height of the die-head off the surface of the belt: this is adjustable, and is a simple matter of changing the length of the “wand” holding the die-head in position on the laminator (a shorter wand would increase the height off the belt surface, a longer wand would reduce this distance). At the same time, this height impacts on the thickness of the layers because, as the material stream is discharged, it will stretch and thin out before hitting the belt surface.

The velocity of the material exiting the die-head—this influences the degree of taper of the material stream as it falls, by gravity, between the die-head discharge and the belt surface. This is regulated to a large extent by the throughput of the materials through the die-head, and the distance that the materials fall before hitting the belt surface.

Belt speed, and the speed of the laminator—these two operations need to be synchronized such that the material falling onto the conveyor belt surface is allowed to fall upon itself, thus creating a “festooning” effect, and building a controlled height of the material sheet on the surface of the belt. At the same time, the die-head will move across the width of the belt, reach its maximum arc, and return in the opposite direction again until it reaches its maximum arc, before repeating the movement on a continuous basis. The belt needs to be running slowly enough so that a continuous sheet is formed—there is some overlap of tapered materials on the extruded sheet, but this cannot be avoided and actually contributes to the “randomly uniform” layering effect in the finished product.

Preferably, a moving die-head is used, generally using only one axis, but a stationary head or co-axial extrusion can also be used effectively. For single-axis co-extrusion, the extrusion slots are orientated such that the length of the slots moves across the width of the belt, meaning that the leading edge of the extruded material stream is narrow and facing the direction in which the belt is moving.

Dependant on the materials being used, the discharge temperatures of the two materials will vary. For the aerated high-boil sugar solution, the mass may exit the die-head at a temperature of between 80° and 110° C., while the fat-based material (such as an almond praline) may exit at a temperature of between 32° and 40° C. This extrusion process will help to cool the sugar material and heat up the fat-based material, with the final outcome being an increased viscosity of the tapered material stream, this helping to prevent the uncontrolled flow of the extruded materials off the edges of the belt.

The extruded sheet of confectionery mass may then enter a cooling tunnel where final cooling and conditioning of the sheet is completed. It is preferred that the cooling is slow and uniform. Preferred temperatures are from 20° to 38° C., for a period of between 10 and 30 minutes. The product sheet formed as a result of this process is tempered under controlled conditions to allow for even cooling and formed into the desired formats using standard confectionary equipment. The confectionery mass may be formed into bars or pieces at a cutting station and optionally enrobed in chocolate or the like. Enrobing may protect the hygroscopic nature of the confectionery mass. Finally, the product may be packaged.

According to the present invention, the thickness of the material stream can be varied by varying the distance between the coaxial die assembly and the conveyor belt and potentially by the slinging action of the oscillating die. The thickness of the material stream (i.e., the fat-based material encased in the high-boil sugar material) may be from about 1 mm to about 80 mm. Preferably, the thickness of the material stream is from about 2 mm to 15 mm, more preferably from about 5 mm to 10 mm.

In addition, the thickness of the resulting stack (i.e., the number of layers of centre-filled strips) can also be varied. The number of layers in the stack may vary from about 1 layer to 500 layers. Preferably, the number of layers in the stack varies from about 3 layers to 20 layers, most preferably about 5 layers to 10 layers. The thickness of the stack may vary from about 5 mm to 10 cm. Preferably, the thickness of the stack is from about 1 cm to 4 cm, most preferably from about 2 cm to 3 cm. Thus, the process permits both the number of layers and the thickness of the layers to easily be varied. Since the texture of the layered structure is determined by the number of layers and the thickness of the layers, the method provides improved control over the texture of the final confectionery mass.

The level of aeration in the high-boil sugar solution may be determined by various factors, including the quality and quantity of sodium bicarbonate added into the syrup stream, as well as the type of mixing process used to allow the sodium bicarbonate to react. Thereafter, the discharge pump supplying aerated high-boil sugar to the die-head may negatively impact on the aerated structure, but this depends on the type of pump selected—a high-shear, vigorous pump may collapse the aerated structure, while a more gentle action will help to maintain the structure. The die-head itself will not affect the aerated structure because the design allows for easy, rounded flows through the die-head. However, the subsequent cooling process and the rate of cooling will likely have an impact on the texture of the final product—with an aerated high-boil sugar solution, a slow, controlled tempering is preferred so that even cooling throughout the product sheet is accomplished. If cooling is too severe at this point (shock-cooling), it is likely that the outer surface will crystallize and prevent the escape of heat from the centre of the sheet, which will ultimately result in the core remaining hot for an extended period and collapse the aerated structure.

### EXAMPLE 1

### Formulation of Chemically Aerated High-Boil Sugar Material

Formulation

| | |
|---|---|
| Granulated Sugar: | 48.791% |
| 42 D.E. Glucose Syrup: | 34.629% |
| Water: | 14.693% |
| Sodium Bicarbonate: | 1.205% |
| Gelatine: | 0.682% |

Method

The gelatine was added with the necessary amount of water in order to properly hydrate. This mixture was then heated to approx. 162° F.

The sugar, glucose syrup, and water was then mixed and heated to approx. 230° F. This gelatine solution is then added and the entire mixture is heated to a final cook temperature of approx. 298° F. It is then allowed to cool to no lower then 250° F.

The sodium bicarbonate powder was then added to the high-boil syrup in a twin screw extruder.

Results

An aerated high-boil sugar material was successfully made by mixing a high-boil sugar material with sodium bicarbonate powder using a twin screw extruder. This eliminates the need for a sodium bicarbonate slurry and also makes the sodium bicarbonate more effective in aerating the high-boil syrup.

### EXAMPLE 2

Formulation

| | |
|---|---|
| Granulated Sugar | 40.516% |
| Peanut Butter | 32.663% |
| High Maltose Corn Syrup | 18.291% |
| Water | 5.213% |
| Honey | 1.307% |
| Sodium Bicarbonate | 1.005% |
| Invert Syrup | 1.005% |

Method

The milled sodium bicarbonate powder was added to the equal quantity of invert sugar and blended using a Silverson high-shear mixer until the mix felt smooth to the touch with no evidence of grit.

The sugar, corn syrup, water and honey were then mixed and heated to a temperature of 298° F. The mass was then allowed to cool to no lower then 250° F.

The peanut butter was heated to a temperature of 120° F.

The high boil syrup and sodium bicarbonate slurry were then combined in a pin-mixer at a speed of 9.5 rpm. The high boil syrup was pumped into the pin mixer at a rate of 2.4 kg per minute and the sodium bicarbonate slurry was pumped into the pin mixer at a rate of 51 grams per minute.

The aerated high boil was then co-extruded with the peanut butter in the co-axial, oscillating die head at a ratio of one third peanut better to two thirds aerated high boil on a volume basis. The specifications of the die head used were:

Centre Slot: Length of slot=6.6675 cm
Width of slot=0.2381 cm
Available surface area=1.5875 cm²

Encapsulating Slot: Length of slot=7.3025 cm (×2)
Width of slot=0.15875 cm (×2)
Approximate available surface area=2.3185 cm².

The co-extruded mass was then cooled via a conventional confectionery cooling tunnel.

Results

A product containing layers of aerated high-boil sugar material interspersed with layers and pockets of peanut butter was formed. The product was crunchy and fractured well in the mouth. In tests, the product was not described as tooth-packing.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A confectionery mass comprising a high-boil sugar material interspersed with layers of a fat-based material, the high-boil sugar material being chemically aerated.

2. A confectionery mass according to claim 1 having a density of from 0.4 g/ml to 1.2 g/ml.

3. A confectionery mass according to claim 1 wherein the high-boil sugar material is chemically aerated and has a density of from 0.3 g/ml to 0.8 g/ml.

4. A confectionery mass according to claim 1 wherein the fat-based material is aerated.

5. A confectionery mass according to claim 4 wherein the fat-based material has a density of from 0.3 g/ml to 0.8 g/ml.

6. A confectionery mass according to claim 1 wherein the ratio of high-boil sugar material to fat-based material is from 60%:40% to 40%:60% based on the weight of the materials.

7. A confectionery mass according to claim 1 wherein the layers of high-boil sugar material have an average thickness of from 0.5 mm to 50 mm.

8. A confectionery mass according to claim 1 wherein the layers of fat-based material have a thickness of from 0.25 mm to 30 mm.

9. A method of making a confectionery mass comprising:
chemically aerating a high-boil sugar material;
extruding a stream of a fat-based material and the high-boil sugar material onto a support, wherein the fat-based material and the high-boil sugar material are not miscible;
extruding subsequent material stream upon an earlier-extruded material stream on the support to create a laminated confectionery mass.

10. The method of claim 9 comprising chemically aerating the fat-based material.
